(19) United States
(12) Patent Application Publication
(10) Pub. No.: US 2008/0132606 A1
(43) Pub. Date: Jun. 5, 2008

(54) Crackle finish powder compositions and coatings and films made therefrom

(76) Inventors: Timothy J. Dotterer, Birdsboro, PA (US); Catherine Kleckner, Bethel, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/985,172

(22) Filed: Nov. 14, 2007

Related U.S. Application Data
(60) Provisional application No. 60/872,325, filed on Dec. 1, 2006.

(51) Int. Cl. C09D 5/03

(52) U.S. Cl. 523/205

(57) ABSTRACT

The present invention provides powder compositions that form films or coatings exhibiting a distressed effect having visible, natural looking color segregation. The compositions comprise film-forming component powders comprising one or more polymer or resin, one or more texturing agent, and a pigment or colorant component comprising one or more pigment or colorant powder. When the compositions are cured or melt flowed to form a coating or film, the color, tint or hue of the said film-forming component powder differs visibly from the color, tint or hue of the said pigment or colorant component. Preferably, the texturing agent comprises a film-forming polymer that does not melt or coalesce under intimate mixing conditions, such as, for example, cellulose acetate butyrate (CAB). The present invention provides finishes that mimic the look of leather or stone with one application of a single powder composition made in one intimate mixing step.

This application claims the benefit of priority under 35 U.S.C. §119(e) of U.S. Patent Application No. 60/872,325, filed on Dec. 1, 2006, the disclosure of which is incorporated herein by reference

The present invention relates to coating powder compositions for making distressed-effect or cracked paint finishes, methods of making the coatings therefor, and the coatings and films produced thereby. More specifically, it relates to powder compositions comprising a film-forming polymer or resin component, a texturing agent or a texturing agent powder, and a discrete pigment or colorant component, e.g. separate powder post-blended with the film-forming powder, and to methods comprising post-blending pigment or colorant component with a coating powder having a texturing agent, and to the natural look finishes having a segregated color effect, e.g. leather look finishes, produced thereby.

Distressed-effect or cracked paint finishes have been prized for their aesthetic qualities. Such finishes generally have been used on metal substrates to mimic a natural appearance, such as by providing, among others, a faux antique look, a faux marble or stone look, a faux leather look, and various appearances that look textured but have a relatively smooth feel or an even film build.

Powder coatings have been used to provide highly durable distressed-effect finishes. However, known processes used to create distressed-effect powder coating finishes have required two or more powder and/or liquid applications, and usually involve the application or design of at least one coat by hand. Further, when any liquid coating layer is applied, the entire coating, including overspray, can no longer be reclaimed and one loses a key advantage of powder coatings.

U.S. Pat. No. 5,856,378, to Ring et al. disclose agglomerated coating powders comprising texturing agents and various intimate mixing methods for making coating powder agglomerates. Ring et al. disclose heavy texture finishes or “cracked-ice” finishes from one application of coating powder. The heavy texture finishes provided by Ring et al. might have a very rough texture in a single color, similar to a terra cotta, gator or starburst finish. However, the Ring et al. composition fails to provide any finish that effectively migrates and segregates color in a texture and the composition fails to provide any natural look finish that has a natural looking segregation of two or more colors, shades or hues, or that has the appearance of leather. Further, Ring et al. disclose only colorants or pigments that in coatings or films cannot be distinguished from other colorants or pigments by the naked eye. In fact, Ring et al. seek to provide only compositions that provide coatings of a uniform or single color. Accordingly, the Ring et al. composition fails to provide compositions and methods for creating a distressed effect color finish that has the appearance of leather or other natural materials, such as granite or marble.

The applicants have endeavored to solve the problem of providing in one intimate mixing step a composition that in a single coating application yields a powder coating finish that has the appearance of leather, stone or other natural look finishes having a non-uniform, segregated color effect.

The present invention provides powder compositions comprising a film-forming component powder comprising one or more polymer or resin, one or more texturing agent, and a pigment or colorant component comprising one or more pigment or colorant powder, wherein when the composition is cured or melt flowed to form a coating or film, the color, tint or hue of the said film-forming component powder differs visibly from the color, tint or hue of the said pigment or colorant component.

The texturing agent may be chosen from a film-forming polymer that does not melt or coalesce under intimate mixing conditions, a micronized wax, a texturing agent powder and a mixture thereof. The texturing agent powder may be chosen from a polymer flow aid powder, such as cross-linked acrylic copolymer powder, a polymer or resin powder that is incompatible with the film-forming component, a film-forming polymer powder that does not melt or coalesce under intimate mixing conditions, a micronized wax powder, and any mixture thereof. The texturing agent may be used in amounts of 10.0 wt. % or less, preferably, 5.0 wt. % or less, or, more preferably, 3.0 wt. % or less, based on the total weight of the powder composition. Preferably, the texturing agent is cellulose acetate butyrate (CAB), or other cellulosics that do not melt or coalesce under intimate mixing conditions.

In a preferred embodiment, to limit contamination of other powders and to limit powder segregation on storage where the texturing agent is chosen from a film-forming polymer that does not melt or coalesce under intimate mixing conditions, a micronized wax, a polymer flow aid powder, or mixtures thereof, the texturing agent comprises a masterbatch with an inert carrier, such as a metal oxide, silica or a silicate.

Preferably, the pigment or colorant component is weatherable, and comprises one or more powder chosen from a metal oxide powder, e.g. an iron oxide, a carbon black, a mixed metal oxide, a metal silicate, a metal oxide silicate, a mixed metal oxide silicate, a metal carbonate powder, e.g. calcium carbonate, an opacifier pigment powder, an organic pigment masterbatch with any weatherable carrier, and any mixture thereof.

In addition, the present invention provides methods for making powder compositions that form distressed effect finishes, the methods comprising intimately mixing a film-forming component and, one or more texturing agent to form a coating powder, and blending with the coating powder a pigment or colorant powder component, wherein when the texturing agent comprises one or more texturing agent powder, the texturing agent is blended with the coating powder.

All ranges recited are inclusive and combinable. For example, an amount of texturing agent ranging 0.005 wt. % or more, for example, 0.05 wt. % or more, or, 0.1 wt. % or more, and which may range to 5.0 wt. % or less, or, 3.0 wt. % or less, or, preferably, 1.0 wt. % or less, will include all ranges of from 0.005 wt. % to 5.0 wt. %, from 0.05 wt. % to 5.0 wt. %, from 0.1 wt. % to 5.0 wt. %, from 0.005 wt. % to 3.0 wt. %, from 0.05 wt. % to 3.0 wt. %, from 0.1 wt. % to 3.0 wt. %, and from 0.005 wt. % to 1.0 wt. %, from 0.05 wt. % to 1.0 wt. %, and from 0.1 wt. % to 1.0 wt. %.

All phrases comprising parenthesis denote either or both of the included parenthetical matter and its absence. For example, the phrase “(co)polymer” includes, in the alternative, polymer, copolymer and mixtures thereof.

As used herein, the phrase “acrylic” refers to acrylic acid containing materials, methacrylic acid containing materials, acrylate containing materials, methacrylate containing materials, and materials containing combinations thereof.

Unless otherwise indicated, as used herein, the term “average particle size”, refers to the particle diameter for which fifty percent of the total volume of the sample is in larger particles and fifty percent is in smaller particles, as determined by laser light scattering using a Malvern Mastersizer™ 2000 instrument (Malvern Instruments Inc., Southboro, Mass.) per the manufacturer's recommended procedures.

As used herein, the phrase “coating powder” refers to a powder coating composition and the phrase “powder coating” refers to a coating formed from a coating powder.

Unless otherwise indicated, as used herein, the “glass transition temperature” or “T_{g}” of a resin or (co)polymer is measured using differential scanning calorimetry (DSC) at a heating rate of 20° C. per minute under nitrogen atmosphere, the T_{g} being reported at the inflection point of the transition. T_{g} may alternatively be calculated as described by Fox in Bull. Amer. Physics. Soc., 1, 3, page 123 (1956).

As used herein, the term “intimate mixing” or “intimately mixing” means extruding, melt-mixing, heat-welding, granulating, mechanically fusing, agglomerating, or masterbatching two or more solid or powder materials with one another to form a single component. Thus, one powder can be formed from two or more materials by intimately mixing them.

As used herein, unless otherwise indicated, the phrase “per hundred parts resin” or “phr” means the amount, by weight, of an ingredient per hundred parts, by weight, based on the total amount of resin, reactant monomer, and (co)polymer contained in a composition, including cross-linking agents, curing agents and any reactive additive, such as an additional polymer or resin.

As used herein, the term “polymer” includes (co)polymers that are the reaction product of any number of different monomers, such as terpolymers, and tetra polymers, and, further, includes random, block, segmented and graft copolymers, and any mixture or combination thereof.

As used herein, the term “powder” refers to discrete, free-flowing particles or fines of one material or, if formed by intimate mixing of two or more materials, particles or fines comprising the two or more materials so intimately mixed.

As used herein, the term “specific gravity” refers to the density of a given substance divided by the density of water.

As used herein, the phrase “wt. %” stands for weight percent.

As used herein the weight percentage of masterbatched materials refers to the actual percentage of masterbatched material based on the total weight of the composition. For example, a powder composition having 1 wt. %, based on the total weight of the powder composition, of a 10/90 masterbatch of CAB in CaCO₃ comprises 0.1 wt. % of CAB.

Texturing agents in powder compositions create both a textured appearance and enhanced incompatibility between a film-forming component and discrete powder materials, i.e. not intimately mixed with the film-forming component. The applicants have discovered that providing powder compositions having one or more texturing agent and one or more pigment or colorant powder creates a natural looking segregated color effect in the coating or film. The compositions of the present invention provide a natural look color and texture appearance without the need for application of powder or liquid by-hand to create the desired color look. Further, the pigment or colorant powder does not rub off in the coating or film even though it is not intimately admixed with the film-forming component. The compositions therefore enable the provision of coatings or films that can have the appearance of natural leather, granite, stone or earth in one application of a single coating made in a single intimate mixing step.

In the powder compositions of the present invention, any film-forming component may be used in the powder composition, so long as it has a T_{g} of 25° C. or higher, preferably 30° C. or higher. Suitable film-forming components may be chosen from polyester, epoxy, acrylic, urethane, polyamide, epoxy-polyester hybrids, epoxy-acrylic hybrids, polyester-acrylic hybrids, and mixtures thereof. The term “hybrid” means an intimately mixed combination of film-forming powders.

Suitable film-forming components may comprise any polymer or resin having a T_{g} or 25° C. or higher, preferably 30° C. or higher. Such a polymer or resin may be chosen from one or more thermosetting polymer or resin, thermoplastic polymer, or ultraviolet (UV) curable polymer or resin. Thermosetting polymers or resins may be chosen from, for example, polyester, epoxy polymer or resin, urethanes, acrylic polymer, acrylic resin, epoxy-polyester hybrids, acrylic-polyester hybrids and acrylic-epoxy hybrids. Thermoplastic polymers can be chosen from polyamides, polyolefins and fluoroolefin polymers, such as polytetrafluorethylene. UV curable polymer or resins can be chosen from unsaturated polyesters, di(meth)acrylates of thermosetting polymers, resins or prepolymers, such as polyols and polyisocyanates, and vinyl ether resins.

The film-forming component may comprise a low temperature curing composition, such as UV curable polymer or resin, or an epoxy or epoxy-polyester hybrid resin with a low temperature curing agent, such as, for example, imidazole adducts of epoxy resins, e.g. isopropyl imidazole or phenyl imidazole adducts of bisphenol epoxy resins, diamine adducts of bisphenol epoxy resins, or polyamine adducts of epoxy resins and. Preferably, the epoxy resins in low temperature curing agents comprise bisphenol A or F epoxy resins.

Texturing agents useful in the present invention include any that flow in the formation of a film or coating. Accordingly, suitable texturing agents melt or flow at a temperature equal to or below the curing or flow out temperature used to make the coating or film, which may range, depending on such factors as the chemistry of the film-forming component powder and the substrate chosen, from 125° C. to 400° C., preferably from 150° C. to 300° C., more preferably, 225° C. or less.

Texturing agents may have an average particle size of from 1.0 um up to the total thickness of the final coating film or 75 um, whichever is less, preferably, 30 um or less, and, more preferably, 20 um or less. Smaller particle sizes insure more consistent film appearance. Micronized texturing agents, such as micronized polymers or waxes, may preferably have an average particle size of 15 um or less. If necessary the texturing agent can be (re)ground or jet milled to a desired particle size prior to use.

Film-forming polymers that do not melt or coalesce under intimate mixing conditions may be chosen from high molecular weight thermoplastics, for example, cellulosics, including, for example, cellulose alkyl ethers, e.g. ethyl cellulose, cellulose esters, e.g. cellulose acetate butyrate resin (CAB), cellulose acetate propionate, or cellulose acetate. As used herein, the term “high molecular weight” means a number average molecular weight (Mn) of 15,000 or more, preferably, 20,000 or more, and, more preferably, 25,000 or more. Examples of film-forming polymer texturing agents that do not melt or coalesce under intimate mixing conditions include, for example, CAB-551-0.01 (Mn of 16,000) and CAB-551-0.02 (Mn of 30,000) cellulose acetate butyrates (Eastman Chemical, Kingsport, Tenn.) and Ceraflour™ 967 thermoplastic synthetic polymer texturing agents (Altana Chemie, BYK Chemie, USA Division, Wallingford, Conn.).

Suitable micronized waxes may be chosen from micronized polymeric waxes, micronized microcrystalline waxes, micronized low molecular weight polyolefins, micronized mineral waxes, micronized acidic waxes, e.g. montan wax, palm wax or beeswax; micronized amides and esters of acidic waxes, e.g. amides or esters of acids or waxes chosen from montanic acid, abietic acid, beeswax, C₁₆ to C₄₀ (aryl)alkanoic acids, C₁₆ to C₄₀ (aryl)alkanedioic acids, and C₁₆ to C₄₀ (aryl)alkenoic acids; and micronized (partially) hydrogenated waxes. Suitable micronized wax texturing agents include Ceraflour™ 960 micronized amide wax texturing agent (Altana Chemie, BYK Chemie, USA Division, Wallingford, Conn.).

Suitable polymer flow aid powders may include, for example, acrylic copolymers, preferably, cross-linked (meth)acrylate copolymers, such as, for example, copolymers that are the polymerization product of monomers chosen from butyl acrylate, ethyl acrylate, methyl methacrylate, ethylhexyl methacrylate, a mixture of any C₁ to C₁₂ (aryl)alkyl (meth)acrylate and styrene, and any mixture thereof. The polymer flow aid powder and the film-forming component powder are not intimately mixed because intimately mixing the two will cause the polymer flow aid to flow, thereby, making the film-forming component and the polymer flow aid compatible and eliminating the texturing agent effect of the polymer flow aid. One example of a polymer flow aid powder is acrylic polymer having a weight average molecular weight of about 17,000, made from 60 mole percent 2-ethylhexyl methacrylate and about 40 mole percent ethyl acrylate. Suitable polymer flow aid powders are available from several suppliers, e.g., Resiflow™ P67 acrylic flow aid (Estron Chemical Inc., Calvert City, Ky.), Modaflow™ flow agents (Monsanto Company, St. Louis. Mo.), Acronal™ or Acronal™ 4F (micronized n-butyl acrylate copolymer, BASF Aktiengesellschaft, Leverkusen, Del.), Modarez™ MFP (Protex, Paris, FR), EX 486 (Troy Chemical, Burton, Ohio), BYK 360P (Altana Chemie, BYK Chemie, USA Division, Wallingford, Conn.) and Perenol™ F-30-P (Henkel Corp., King of Prussia, Pa.).

The polymer or resin powder that is incompatible with the film-forming component can be any film forming polymer or resin having a suitable T_{g} of 25° C. or higher, preferably 30° C. or higher. The polymer or resin powder that is incompatible with the film-forming component can comprise a polymer resin, and can be, for example, a coating powder composition comprising one or more pigment and/or colorant. Suitable incompatible polymer or resin powder/film-forming component combinations may include, for example, epoxy resin powder/polyester, epoxy resin powder/acrylic, acrylic powder/polyester, acrylic powder/epoxy resin, urethane powder/polyester, urethane powder/epoxy resin, urethane powder/acrylic, polyamide powder/polyester, polyamide powder/acrylic, and polyamide powder/epoxy resin. When used as texturing agents, the polymer or resin powder that is incompatible with the film-forming component and the film-forming component should not be intimately mixed in a way as to make the texturing agent polymer or resin powder flow. Preferably, the polymer or resin powder that is incompatible with the film-forming component is combined with the film-forming component after intimate mixing.

The amount of texturing agent present in the powder compositions depends, among other things, upon the texturing agent chosen, film-forming component powder chosen and the pigment or colorant chosen. Any texturing agent may be used in amounts of 5 wt. % or less, based on the total weight of the powder composition. Suitable amounts of texturing agent powders may range up to 10.0 wt. %, based on the total weight of the powder composition.

If more than 10.0 wt. % of any texturing agent powder is used, the texturing agent will tend to stratify as the discrete particles start to coalesce and, ultimately, producing a continuous film as is evidenced by increasing gloss in the coating or film. Further, use of more than 10.0 wt. %, based on the total weight of the powder composition, of any texturing agent powder, may result in powder blocking problems and difficulty in application.

Use of more than 5.0 wt. %, based on the total weight of the powder composition, of any film-forming polymer texturing agent that does not melt or coalesce during intimate mixing or any micronized wax texturing agent can lead to clumping during application and powder blocking or segregation during storage. Further, texturing agents may form non-textured low gloss coatings or films when used in the amount of more than 5.0 wt. % or, based on the total weight of the composition. Texturing agents can generally be used in the amount of 5.0 wt. % or less, or 3.0 wt. %, based on the total weight of the composition, preferably 1.0 wt. % or less.

The amount of texturing agent needed to give the desired of the present invention finish will vary depending on the overall flow of a powder composition during the formation or curing of a coating or film. In general, texturing agents or texturing agent powders should comprise 0.01 wt. % or more, based on the total weight of the powder composition, preferably 0.1 wt. % or more, or, preferably, 0.1 wt. % to 0.3 wt. %. The use of 0.01 wt. % or less of any texturing agent or texturing agent powder, based on the total weight of the composition, may lead to a hammertone finish that does not feature consistent color segregation. However, as little as 0.005 wt. % of texturing agent or texturing agent powder may provide a suitable color segregation effect where the pigment or colorant powder comprises a low oil absorption pigment or colorant. Low oil absorption pigments are defined as those having average oil absorption value as measured by ISO 787-5:1980 of 60 ml/100 g of material or less, preferably, 40 ml or less. Further, less texturing agent or texturing agent powder may be needed to provide a suitable color segregation effect where a film-forming component powder has a low T_{g}, e.g. of 50° C. or less. Still further, less texturing agent or texturing agent powder is needed to provide a suitable color segregation effect when used with a film-forming component powder having a hot plate melt flow at 191° C. of 60 mm or higher.

In embodiments where the texturing agent flows excessively during the formation of a coating or film, such as where the texturing agent comprises a micronized wax, the resulting film may have defects or pinholes. In such embodiments, the number of defects in the resulting film can be reduced by any method of reducing flow or incompatibility in the powder composition, the method chosen from use of less texturing agent, use of a film-forming component that has a T_{g} of 55° C. higher, use of curing agents that increase curing speed, lowering cure temperature, shortening cure time, use of catalysts to increase cure speed, use of more filler or pigment, use of a higher oil absorption filler or pigment, and use of a matting agent.

In the methods of forming the powder compositions, texturing agent powders, such as the polymer flow aid or (incompatible) polymer or resin powder texturing agent that is incompatible with the film-forming component, are not intimately mixed with the film-forming component because intimate mixing may make the polymer or resin texturing agent compatible with the film-forming component powder. In addition, the film-forming component may not be intimately mixed with texturing agents chosen from film-forming polymers that do not melt or coalesce under intimate mixing conditions and micronized waxes; however, this is not preferred because these texturing agents may contaminate other powder compositions and because the powder compositions resulting from this these methods are not reclaimable.

The pigment or colorant component is chosen so that the color, tint or hue of the film-forming component powder and the color, tint or hue of the pigment or colorant component differs visibly in a cured or flowed (thermoplastic) film or coating. Whether or not the film-forming component powder comprises a pigment or colorant, the film-forming component powder has a color, tint or hue that differs visibly from the color, tint or hue of the pigment or colorant component and/or the color, tint or hue of each may become different due to the cure or flow of the powder composition, such as, for example, through use of thermochromic pigments.

Suitable pigment or colorant powders for the pigment or colorant component may comprise any one or more pigment or colorant that segregates from the film-forming component powder during melt or cure to form a coating or film. In general, a suitable pigment or colorant powder is any having a specific gravity of 6.5 or less, preferably, 5.8 or less. Suitable pigments or colorants may be chosen from inorganic pigments or colorants, organic pigments or colorants, and organic pigments or colorants masterbatched on inorganic carriers. Low oil absorption pigments or colorants allow the formation of the desired color segregation effects with less texturing agent. Preferably, the pigment or colorant powder is weatherable and, thus, may be chosen from a metal oxide, a carbon black, a mixed metal oxide, a metal carbonate, an opacifier pigment, a metal silicate, a metal oxide silicate, a mixed metal oxide silicate, an organic pigment masterbatched with a weatherable pigment or silica carrier, and any mixture thereof. More preferably, the weatherable pigment or colorant powder may be chosen from iron oxides, mixed oxides of iron, metal oxide silicates, carbon black, metal silicates, mixed metal oxide silicates, metal carbonates, e.g. calcium carbonate, and opacifier pigments.

Inorganic pigment or colorant powders may be chosen from metal oxides, mixed metal oxides, metal (sub)carbonates, metal silicates, mixed metal silicates, silicates of metal oxides, and metal titanates.

Suitable powders of metal oxides may be chosen from iron oxides, of various colors, for example, iron oxide red, iron oxide brown, iron oxide yellow, iron oxide orange, titanium dioxide, zinc oxide; cobalt oxide, aluminum oxide, titanium dioxide, and chromium (III) oxide;

Suitable powders of mixed metal oxides may be chosen from cobalt blue, of iron and tin, mixed oxides of iron and aluminum, mixed oxides of iron and magnesium, mixed oxides of iron and chromium, mixed oxides of iron and copper, mixed oxides of aluminum and cobalt, and mixed oxides of iron and cobalt.

Suitable powders of metal (sub)carbonates may be chosen from calcium carbonate, strontium carbonate, and alkali(ne) metal subcarbonates.

Suitable powders of metal titanates may be chosen from nickel titanates, copper titanates, zinc titanates, buff titanates and blue titanates.

Suitable opacifier pigment powders may be chosen from calcium carbonate, barytes, blanc fixe, zinc sulphide, zinc white, titanium dioxide, talc, mica, clay, and kaolin, boron nitride, zinc phosphate dihydrate or tetrahydrate, zinc oxide, magnesium oxide, diatomaceous earth and oxidized diatomaceous earth.

Suitable metal silicate pigment or colorant powders may be chosen from ultramarine blue, wollastonite, aluminum alkali(ne) silicates, feldspar, zeolites, mica, coated mica, talc, china clay, calcined silicates, calcined clays.

Suitable organic pigment powders may be chosen from carbon black, such as activated carbon black; disazo pigments; masterbatches of disazo pigments masterbatches of quinacridones on a weatherable carrier, such as quinacridone red, quinacridone violet; masterbatches of copper phthalocyanines on a weatherable carrier, such as copper phthalocyanine blue or green. Suitable weatherable carriers may be, e.g., a metal oxide, a metal silicate, silica, a clay, or a metal carbonate.

Low oil absorption pigment powders suitable for use in the powder compositions may be chosen from metal oxides, mixed metal oxides, carbon blacks, calcium carbonate, silica, magnesium silicate, aluminum silicates, mica, bentonite, magnesium alumino-silicate, fumed alumina, colloidal attapulgite, synthetic amorphous sodium alumino-silicates, sodium potassium alumino-silicates, and cadmium selenide orange. As used herein, the term “oil absorption” is defined by the amount of oil required by a given weight of a particulate material to form a paste of specified consistency and is measured according to ISO 787-5:1980, using linseed oil; “low oil absorption” refers to any material having an oil absorption of 60 ml oil/100 g material or less.

The pigment or colorant component may be used in amounts of from 0.1 wt. % or more; the amount may range 10 wt. % or less. Use of more than 10 wt. % pigment or colorant powder, based on the weight of the total powder composition, may result in coatings or finishes that rub off. Preferably, the amount of pigment or colorant powder may range 5 wt. % or less, or 3 wt. % or less. To insure a segregated color effect, the preferred amount of pigment or colorant powder may range 0.5 wt. % or more.

The film-forming component powder of the present invention may comprise a film-forming polymer or resin powder. Further, it may suitably comprise one or more texturing agent, and known additional ingredients, such as, for example, curing agents, pigments or colorants, fillers, matting agents, melt flow aids, catalysts, wrinkle forming catalysts, leveling agents or degassing additives, light stabilizers, anti-corrosives, mold release agents and antioxidants. One or more of each of the pigments or colorants, e.g. titanium dioxide, carbon black, organic phthalocyanines, hollow sphere pigments or opaque polymers; and fillers, such as china clay, barytes, and large size fillers may be used in amounts of from 10 to 120 phr in the film-forming component powder. Curing agents, such as hydroxyalkylamides, polyepoxides, (di)amines and imidazoles may be used with the film-forming component in stiochiometric amounts. Polymer flow aids, aka melt flow aids, including alkyl (meth)acrylate copolymers, and silicones, and mold-release agents, and may comprise 0.1 phr or more, or 0.5 phr or more, or 1 phr or more, and up to 4 phr, or up to 2.5 phr, or up to 1.5 phr in the film-forming component powder; leveling agents, e.g. benzoin (2-Hydroxy-1,2-diphenylethanone) and alkyl ethers and esters of benzoin, and light stabilizers, e.g. hindered amines and hindered phenols, may comprise from 0.1 to 4 phr, for example, 0.2 or more phr, in the film-forming component powder; anticorrosives such as zinc phosphate, other metal phosphates, and phosphorous containing polyesters may comprise amounts ranging up to 20 phr, for example, from 0.01 to 10 phr, or up to 5 phr of the film-forming component powder; antioxidants, such as benzotriazole, may comprise amounts of from 0.1 to 1 phr of the film-forming component powder; dry flow aids, such as fumed silica and alumina, and fumed silica treated with alkoxysilanes, may be added to film-forming component powder in amounts of from 0.1 phr or more, or 0.5 phr or more, and up to 1.5 phr, or up to 1.0 phr.

The powder compositions are made by methods wherein the pigment or colorant component is mixed with the film-forming component powder after the film-forming component powder is formed by intimate mixing, i.e. they are post-blended. Powder compositions containing post-blended material are susceptible to segregation which causes inconsistency in the texturing effect on application of the powder and causes blocking on storage. Further, as only small amounts of texturing agents are needed to form a distressed effect coating, contamination of other coating powders may easily occur and should be minimized. To solve powder segregation, blocking and contamination issues, any texturing agent chosen from a film-forming polymer that does not melt or coalesce under intimate mixing conditions, a micronized wax, a polymer flow aid powder, or mixtures thereof, may comprise a masterbatch with an inert carrier, such as a metal oxide, silica or a silicate, an extender pigment, e.g. calcium carbonate, or a dry flow aid, e.g. silica or fumed alumina. For example, a polymer flow aid texturing agent powder may be masterbatched, e.g. by high shear blending. One suitable masterbatch is Uralac™ P3188 (DSM, Heerlen, NL), carboxy-functional saturated polyester resin containing 10% w/w of Acronal™ 4F flow aid.

In other embodiments, masterbatches may enable use of a suitable organic pigment or colorant that is liquid or tacky at room temperature. Masterbatching the organic pigment with an inorganic carrier may insure it the pigment or colorant is solid when used and to prevent segregation of the organic pigment or colorant from the remainder of the powder composition. Further, masterbatching organic pigments with weatherable inorganic pigments may enable weatherable coatings to include organic pigments.

Masterbatching may comprise blending the texturing agent and/or organic pigment or colorant and the carrier in a mixer, generally at room temperature or below, for a period of 10 min to 24 hours, preferably 120 minutes or less. Suitable mixing device(s) may include any that are capable of providing the shear necessary to bond the carrier to the texturing agent or organic pigment or colorant. The mixing element(s) may comprise one or more mixing chamber having disposed within it one or more mixing element(s) of any shape to provide the shear, e.g. impellers, mixing blades, propellers or combinations thereof. Horizontal mixing chambers or vertical mixing chambers may be suitable. Suitable vertical mixers are available from Plasmec (Lonate Pozzolo, IT), and include liquid cooled mixing blades; other mixers may include those available from Mixaco (Neuenrade, Del.), Hosokawa Cyclomix (Osaka, JP). Suitable vertical and horizontal mixers include those available from Littleford (Florence, Ky., USA) and those carrying the name Henschel. In making any masterbatch, suitable weight ratios of texturing agent or organic pigment to the carrier may range from 0.1:99.9 to 20:80, preferably, 10:90 or less, or, preferably, 0.5:99.5 or more.

Methods of making the film-forming component powder of the present invention comprise intimate mixing methods known and used for making coating powders, including therewith one or more texturing agent in the intimate mix, followed by adding and mixing one or more pigment or colorant powder and, if used, one or more texturing agent powder. Accordingly, powder compositions may be formed, for example, by combining one or more film-forming polymer or resin, one or more texturing agent or masterbatch thereof, and any one or more curing agent, pigment or colorant powder, and/or any additional ingredient(s), except for the dry flow aid, in an extruder, melt mixer, or agglomerating or granulating apparatus, following by drying, adding and mixing one or more dry flow aid, one or more pigment or colorant powder or masterbatch thereof, and, if used, one or more texturing agent powder or masterbatch thereof, and then crushing and grinding to form a powder of the desired particle size. The pigment or colorant powder or masterbatch thereof, and any texturing agent powder or masterbatch thereof may be added and mixed with powder after crushing and grinding, as well as beforehand. If a texturing agent is used, no texturing agent powder need be used, and vice-versa; however, both a texturing agent and a texturing agent powder may be used in a single powder composition.

Adding and mixing dry flow aid, pigment or colorant powder or a masterbatch thereof, texturing agent powder or a masterbatch thereof, may be carried out by known methods for post-blending dry flow aids in the art of making coating powders, such as, for example, bag blending or by mechanically mixing in a low rpm mixer or horizontal mixer, such as a Henschel mixer, for a time ranging from 2 minutes to 6 hours, preferably 60 minutes or less, more preferably, 30 minutes or less.

Powders comprising one or more wax or film-filming polymer texturing agent, that is added and mixed with the film-forming component after it is formed by intimate mixing may clump or cake during application. The resulting powder is, thus, not reclaimable. Accordingly, any texturing agent should be intimately mixed into the film-forming component to form part of the film-forming component powder. However, to insure formation of the desired color segregation effect, texturing agent powder (polymer flow aid and incompatible film former) are added and mixed in with the film-forming component powder after intimate mixing.

The powder compositions comprise a distribution of particles having an average particle size of 10 μm or more, preferably, 15 μm or more, and the average particle size may range to 120 μm or less, or, preferably, 60 μm or less.

The powder compositions may be applied to substrates in any known manner, such as, for example, by electrostatic or triboelectric spray or fluidized bed coating. Alternatively, the powders can be formed into films by extrusion, in-mold coating or on-mold coating techniques, or by compressing the powders either underneath a heated membrane or platen and onto a substrate, or between heated membranes, platens or substrates.

Suitable substrates for coating or film application include metal, primed metal, painted metal, ceramic, concrete, wood, plastic, primed plastic and (ligno)cellulosic substrates, such as paper or paperboard. Coatings made with the coating powders may be decorative and/or weatherable. Substrate articles to be coated with the coating powders may include, for example, building materials, such as aluminum window frames, bathroom and kitchen tile, drain tile and roofing tile and aluminum siding; indoor and outdoor furniture, such as ready to assemble wood and fiberboard furniture and metal or plastic deck furniture; industrial goods, such as pipes, steel springs, sheet metal, steel coils, cans, bottles springs, girders; and, sheet molded composites, laminated articles such as plywood and wallpaper, molded plastic articles, and female molds.

### EXAMPLES 1-10

Masterbatching: Unless otherwise indicated, all masterbatches were made by combining the ingredients in a Prism, Pilot 3 mixer (Thermo Electron, Newington, N.H.) and blending at 1500 rpm for 60 seconds.

Forming Powder Composition: Unless otherwise indicated, in each Example, the film-forming component powder and texturing agent masterbatch raw materials shown in the respective Table were weighed and mixed, incorporated by bag shake for 60 seconds, to form a raw mix. The raw mix was extruded using a Thermo-Prism (Staffordshire, UK) 24 mm (diameter) twin screw extruder, model: TSE 24PC, set at 93.33° C. (200° F.), 400 RPM and a torque of 30 Nm, followed by extruding through a water-jacketed two roll mill to form extrudate chips and then crushing the chips with a rubber mallet. A dry flow aid, fumed alumina, was added to the extrudate chips prior to grinding. The chips were then ground using Brinkman centrifugal grinder equipped with a 1.0 mm screen and a 12 pin rotor. The resulting coating powder was sieved using a 104 um (140 mesh) screen.

The post-blended pigments were weighed, mixed into the coating powder and then cup blended into coating powder fines in 100 gram batches, by shaking for 60 seconds in a 237 ml (8 oz.) cup.

Coating Application and Cure: Unless otherwise indicated, the coating powder in each of Examples 1-10 was applied electrostatically to an ASTM A1008A/A109 (reauthorized 2000), and Fe. Steel Spec. QQ-S-698 compliant cold rolled, low-carbon steel, dull matte panel finish (Q-panel) 0.8×76×127 mm using a Nordson Versa-Spray™ handheld spray gun at 60 kV and 10 psi. Unless otherwise indicated, the thus formed coatings were cured by baking in an electric convection oven at 177° C. (375° F.) for 15 minutes.

### Example 1

### Brown on Tan Finish

TABLE 1

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| 90 wt. % Calcium Carbonate - Limestone | 0.60 |
| 10% Cellulose Acetate Butyrate* | |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 8.86 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Raw Umber - Metal Oxide Silicate | 2.00 |

*Number average molecular weight (Mn)~30,000

### Example 2

### Brown on Tan Finish

TABLE 2

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| 90 wt. % Calcium Carbonate - Limestone | 0.60 |
| 10 wt. % Cellulose Acetate Butyrate* | |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 8.86 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Pigment Brown 23 - Azo condensation (Formula | 1.00 |
| C₄₀H₂₃Cl₃N₈O₈) | |

*Number average molecular weight (Mn)~30,000

### Example 3

### Brown on Tan Finish

TABLE 3

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| 90 wt. % Calcium Carbonate - Limestone | 0.60 |
| 10 wt. % Cellulose Acetate Butyrate* | |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 8.86 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Monazo 1:2 Chrome Complex | 1.00 |

*Number average molecular weight (Mn)~30,000

### Example 4

### Umber on Tan Finish

TABLE 4

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| 90 wt. % Calcium Carbonate - Limestone | 0.60 |
| 10 wt. % Cellulose Acetate Butyrate* | |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 8.86 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Umber - Metal Oxide Silicate | 4.00 |

*Number average molecular weight (Mn)~30,000

### Example 5

### Umber on Tan Finish

TABLE 5

| | Wt. % |
|---|---|
| INGREDIENT | |
| Carboxyl Functional Polyester Resin (Acid number = 35) | 56.46 |
| Triglycidyl Isocyanurate (curing agent) | 4.25 |
| 90 wt. % Calcium Carbonate - Limestone | 0.60 |
| 10 wt. % Cellulose Acetate Butyrate* | |
| 90 wt. % Calcium Metasilicate - Wollastonite | 3.64 |
| 10 wt. % Zinc Neodecanoate (matting agent) | |
| Ethylene Acrylic Acid Copolymer (matting agent) | 3.64 |
| Nepheline Syenite | 15.19 |
| Iron Oxide Yellow | 0.97 |
| Iron Oxide Red | 0.06 |
| Titanium Dioxide | 15.19 |
| POST BLEND | |
| Fumed Alumina | 0.20 |
| Umber - Metal Oxide Silicate | 4.00 |

*Number average molecular weight (Mn) = 30,000

On visual inspection, the coatings in each of Examples 1-4 exhibited the desired natural look, segregated color effect finish. In Example 5, the composition was more difficult to apply and creating the desired effect proved more difficult than in each of Examples 1-4 because of the low amount of texturing agent used (0.06 wt. %) and the reduced flow of the composition resulting from the higher amount of filler used. Nevertheless, the coating of Example 5 exhibited the desired natural look, segregated color effect finish. All coatings in Examples 1-6 exhibit minimal defects or holes.

### Example 6

### White on Grey Finish

In Example 6, the powder composition was re-screened through a 149 um (100 mesh sieve).

TABLE 6

| | Wt. % |
|---|---|
| INGREDIENT | |
| Carboxyl Functional Polyester Resin (Acid number = 35) | 66.90 |
| Triglycidyl Isocyanurate (curing agent) | 5.04 |
| 90 wt. % Calcium Carbonate - Limestone | 0.72 |
| 10 wt. % Cellulose Acetate Butyrate* | |
| 90 wt. % Calcium Metasilicate - Wollastonite | 4.32 |
| 10 wt. % Zinc Neodecanoate (matting agent) | |
| Ethylene Acrylic Acid Copolymer (matting agent) | 4.32 |
| Nepheline Syenite | 7.19 |
| Carbon Black | 0.72 |
| Titanium Dioxide | 10.79 |
| POST BLEND | |
| Fumed Alumina | 0.20 |
| Titanium Dioxide | 3.00 |

*Number average molecular weight (Mn) = 30,000

On visual inspection, Example 6 showed the formation of the desired natural segregated color effect finish in a light color additive (pigment powder) in a dark color base (film-forming component powder). The coating of Example 6 exhibited minimal defects or holes The colors of the lighter pigment powder and the dark film-forming component would have been expected form a textured gray colored finish lacking in color segregation.

### Example 7

### Brown on Beige Finish

TABLE 7

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| 90 wt. % Calcium Carbonate - Limestone | 0.10 |
| 10 wt. % Cellulose Acetate Butyrate* | |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 9.36 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Umber - Metal Oxide Silicate | 4.00 |

*Number average molecular weight (Mn) = 16,000

On visual inspection, the finish of Example 7 exhibited a visible but minimal natural segregated color effect having using only 0.01 weight %, based on the total weight of the powder composition, of a CAB texturing agent. The finish has only a few defects, as holes.

### Example 8

### Brown on Beige Finish

TABLE 8

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| 90 wt. % Calcium Carbonate - Limestone | 0.30 |
| 10 wt. % Cellulose Acetate Butyrate* | |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 9.16 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Umber - Metal Oxide Silicate | 4.00 |

*Number average Mn = 16,000

On visual inspection, the finish of Example 8 exhibited a good natural segregated color effect using only 0.03 weight %, based on the total weight of the powder composition, of a CAB texturing agent having a number average molecular weight of 16,000. The finish rates poorly to fairly in the number of visible defects from flow of the texturing agent to the substrate despite the use of the matting agent to reduce flow.

### Example 9

### Brown on Beige Finish

TABLE 9

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| Micronized Synthetic Polymer (¹Ceraflour ™ 967) | 0.10 |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 9.36 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Umber - Metal Oxide Silicate | 4.00 |

¹Altana Chemie, BYK Chemie, USA Division, Wallingford, CT.

On visual inspection, the finish of Example 9 exhibited a fair natural segregated color effect using only 0.1 weight %, based on the total weight of the powder composition, of a synthetic polymer texturing agent. The finish rates poorly in the number of holes from flow of the texturing agent to the substrate despite the use of the matting agent to reduce flow, suggesting the desirability of further limiting flow in the powder composition.

### Example 10

### Brown on Beige Finish

TABLE 10

| | Wt. % |
|---|---|
| INGREDIENT | |
| Carboxyl Functional Polyester Resin (Acid number = 35) | 54.97 |
| Triglycidyl Isocyanurate (curing agent) | 4.14 |
| Micronized Synthetic Polymer (Ceraflour ™ 967) | 0.30 |
| 90 wt. % Calcium Metasilicate - Wollastonite | 3.55 |
| 10 wt. % Zinc Neodecanoate (matting agent) | |
| Ethylene Acrylic Acid Copolymer (matting agent) | 3.55 |
| Nepheline Syenite | 9.16 |
| Iron Oxide Yellow | 0.65 |
| Iron Oxide Red | 0.03 |
| Carbon Black | 0.01 |
| Titanium Dioxide | 23.64 |
| POST BLEND | |
| Fumed Alumina | 0.20 |
| Umber - Metal Oxide Silicate | 4.00 |

On visual inspection, the finish of Example 10 exhibited a poor segregation of color using 0.3 weight %, based on the total weight of the powder composition, of a synthetic polymer texturing agent. In comparison to Example 9, the finish of Example 10 suggests the desirability of using of less micronized synthetic polymer texturing agent. The finish rates poorly in the number of holes from flow of the texturing agent to the substrate despite the use of the matting agent to reduce flow.

A single spray application of the powder composition of each of the above Examples 1-10 resulted in the desired distressed, segregated color effect in which the colors of the film-forming component and of the pigment or colorant component segregate from each other to form the natural look finish.

We claim:

1. A powder composition comprising a film-forming component powder comprising one or more polymer or resin, one or more texturing agent, and a pigment or colorant component comprising one or more pigment or colorant powder,
wherein, when cured or melt flowed to form a coating or film, the color, tint or hue of the said film-forming component powder differs visibly from the color, tint or hue of the said pigment or colorant component.

2. A powder composition as claimed in claim 1, wherein the said texturing agent may be chosen from a film-forming polymer that does not melt or coalesce under intimate mixing conditions, a micronized wax, a texturing agent powder, and a mixture thereof.

3. A powder composition as claimed in claim 2, wherein the said texturing agent powder may be chosen from a polymer flow aid, a polymer or resin powder that is incompatible with the film-forming component, a film-forming polymer that does not melt or coalesce under intimate mixing conditions, a micronized wax, and a mixture thereof.

4. A powder composition as claimed in claim 1, wherein the said texturing agent is cellulose acetate butyrate (CAB), or other cellulosics that do not melt or coalesce under intimate mixing conditions.

5. A powder composition as claimed in claim 1, wherein the said pigment or colorant component comprises one or more weatherable pigment or colorant powder.

6. A powder composition as claimed in claim 5, wherein the said weatherable pigment or colorant powder is chosen from a metal oxide, carbon black, a mixed metal oxide, a metal silicate, a metal oxide silicate, a mixed metal oxide silicate, a metal carbonate, an opacifier pigment, an organic pigment masterbatch with a weatherable carrier, and any mixture thereof.

7. A powder composition as claimed in claim 1, wherein the amount of the said texturing agent or texturing agent powder ranges from 0.005 wt. % to 5 wt. %, based on the total weight of the said powder composition.

8. A method of making a powder composition comprising:
intimately mixing a film-forming component and one or more texturing agent to form a coating powder, and
blending with the said coating powder a pigment or colorant component comprising one or more pigment or colorant powder,
wherein when the said texturing agent comprises one or more texturing agent powder, the said texturing agent is blended with the said coating powder.

9. An article comprising a substrate coated with the powder composition as claimed in claim 1.

10. A coating or film comprising the powder composition as claimed in claim 1.
